(19) United States
(12) Patent Application Publication
(10) Pub. No.: US 2014/0172507 A1
(43) Pub. Date: Jun. 19, 2014

(54) MERCHANT ATTRITION PREDICTIVE MODEL

(71) Applicant: Girish Menon, Lake Zurich, IL (US)

(72) Inventor: Girish Menon, Lake Zurich, IL (US)

(73) Assignee: DISCOVER FINANCIAL SERVICES LLC, Riverwoods, IL (US)

(21) Appl. No.: 13/717,386

(22) Filed: Dec. 17, 2012

(51) Int. Cl. G06Q 30/02

(52) U.S. Cl. CPC G06Q 30/0204
USPC 705/7.33

(57) ABSTRACT

A method for predictive modeling of merchant attrition in a payment network. The method includes registering a plurality of merchants in the payment network, each merchant associated with at least one merchant acquirer; standardizing merchant registration information for the plurality of merchants to identify duplicate entries; assigning a unique merchant identification to each merchant; receiving transactional data from at least one merchant, the transactional data including at least a transaction amount and a transaction date; building a time series data set for the merchant from the transactional data; determining a merchant category for the merchant based on the primary industry group in which the merchant operates; and calculating a probability for the merchant to switch to a different acquirer based on one of a plurality of attrition models.

### BACKGROUND

This disclosure relates to payment networks and, in particular, to one or more merchant attrition predictive models.

In a typical payment system, a credit card or payment network service provider processes transactions that originate at merchants. A merchant acquirer is typically an intermediate entity between the service provider and the merchant.

In a typical transaction flow, a merchant receives payment card information from a payer through a point-of-sale (POS) terminal. The POS terminal contacts the acquirer for an authorization. The acquirer routes the authorization request to the service provider, which in turn routes the authorization request to the appropriate issuer. In some cases, the service provider and the issuer are the same entity. The card issuer checks the payment card information against a database for available funds for the payer and finds that there are enough funds available. The card issuer passes a unique authorization number back to the service provider. The card issuer also reduces the available funds on the payer's account. The service provider routes the authorization number back to the acquirer who in turn routes it to the appropriate POS terminal of the merchant. This process happens in seconds without human intervention.

However, merchants typically do not stay with any one acquirer for a long time and tend to shop around to get the best rates. This churn is a continuous drain and/or expense for the acquirers, as either revenue lost or acquisition expense to maintain market share. An issuer also feels the impact of this churn as lost network volume or difficulty in closing an acceptance gap.

Accordingly, there remains a need in the art for a system for detecting merchant churn as it happens or in a predictive manner.

### SUMMARY

One embodiment provides a method and computer-readable storage medium for predictive modeling of merchant attrition in a payment network. The method and computer-readable storage medium, when executed, provides for: registering a plurality of merchants in the payment network, each merchant associated with at least one merchant acquirer; standardizing merchant registration information for the plurality of merchants to identify duplicate entries; assigning a unique merchant identification to each merchant; receiving transactional data from at least one merchant, the transactional data including at least a transaction amount and a transaction date; building a time series data set for the merchant from the transactional data; determining a merchant category for the merchant based on the primary industry group in which the merchant operates; and calculating a probability for the merchant to switch to a different acquirer based on one of a plurality of attrition models.

Another embodiment provides a system that includes a merchant registration database, a transaction database, and a service provider computing device executing one or more processors to predict merchant attrition in a payment network, by performing the steps of: registering a plurality of merchants in the payment network in the merchant registration database, each merchant associated with at least one merchant acquirer; standardizing merchant registration information for the plurality of merchants to identify duplicate entries; assigning a unique merchant identification to each merchant; receiving transactional data from at least one merchant, the transactional data stored in the transaction database and including at least a transaction amount and a transaction date; building a time series data set for the merchant from the transactional data; determining a merchant category for the merchant based on the primary industry group in which the merchant operates; and calculating a probability for the merchant to switch to a different acquirer based on one of a plurality of attrition models.

### BRIEF DESCRIPTION OF THE DRAWINGS

FIG. 1 is a conceptual diagram of a payment network, according to one embodiment of the disclosure.

FIG. 2 is a flow diagram of method steps for predicting merchant attrition in a payment network, according to one embodiment of the disclosure.

FIG. 3 is a flow diagram of method steps for standardizing merchant registration information, according to one embodiment of the disclosure.

FIG. 4 is a conceptual diagram illustrating short form translations when standardizing addresses, according to one embodiment of the disclosure.

FIG. 5 is a conceptual diagram illustrating an example of implementing a comparison function, according to one embodiment of the disclosure.

FIG. 6 is a conceptual diagram illustrating a plot of reactivation versus inactivity period organized by merchant category, according to one embodiment of the disclosure.

FIGS. 6A-6C are conceptual diagrams illustrating plots of reactivation versus inactivity period organized by merchant category groupings, according to some embodiments of the disclosure.

FIG. 7 is a conceptual diagram illustrating a plot of reactivation versus inactivity period for different industry categories, according to one embodiment of the disclosure.

FIG. 8 is a conceptual diagram illustrating a merchant life cycle, according to one embodiment of the disclosure.

FIG. 9 is a table illustrating a transformation using half-life, according to one embodiment of the disclosure.

FIG. 10 is a table indicating bivariate analysis results, according to one embodiment of the disclosure.

FIG. 11 illustrates a correlation matrix of only those variables which are highly correlated, according to one embodiment of the disclosure.

FIG. 12 illustrates a Variance Inflation Factor (VIF) output of some of the derived variables which came out to be significant after multi-collinearity analysis, according to one embodiment of the disclosure.

FIG. 13 is a table illustrating variables that emerged as significant drivers of attrition in transformed data, according to one embodiment of the disclosure.

FIG. 14 is graph of actual versus predicted attrition using a regression model with transformed data, according to one embodiment of the disclosure.

FIG. 15 is a lift chart illustrating attrition prediction using the logistic regression model with transformed data, according to one embodiment of the disclosure.

FIG. 16 is a table illustrating variables that emerged as significant drivers of attrition in non-transformed data, according to one embodiment of the disclosure.

FIG. 17 is graph of actual versus predicted attrition using a regression model with non-transformed data, according to one embodiment of the disclosure.

FIG. 18 is a lift chart illustrating attrition prediction using the logistic regression model with non-transformed data, according to one embodiment of the disclosure.

FIG. 19 is a table of variables found to be significant predictors of attrition using the survival mode with transformed data, according to one embodiment of the disclosure.

FIG. 20 is a table of variables found to be significant predictors of attrition using the survival mode with non-transformed data, according to one embodiment of the disclosure.

FIG. 21 is a lift chart illustrating attrition prediction using the survival model with non-transformed data, according to one embodiment of the disclosure.

FIG. 22 is a lift chart illustrating attrition prediction using the logistic regression model, survival model, and neural network model, according to one embodiment of the disclosure.

FIG. 23 is a table of different drivers of merchant attrition, categorized by importance and dependent on industry grouping, according to one embodiment of the disclosure.

FIG. 24 is a table of different drivers of merchant attrition, categorized by importance, according to one embodiment of the disclosure.

FIG. 25 is an example of a computing device configured to implement one or more embodiments disclosed herein, according to one embodiment of the disclosure.

### DETAILED DESCRIPTION

The following examples further illustrate embodiments of the disclosure but, of course, should not be construed as in any way limiting its scope.

Embodiments of the disclosure use merchant and transactional data to predict merchant attrition. In a closed-loop transaction system, the service provider that provided the payment card to the payer is also the same entity as the issuer. As each transaction occurs, the service provider sees within that transaction a merchant name, business name, address, merchant number, and transaction amount. In some embodiments, apart from the transactional data, the service provider may request the acquirers and merchants to submit registration information. The registration information includes data elements as specified in certain operating regulations. Examples of data elements include location information, contact information, merchant category information, and processor characteristics. In one embodiment, both transactional and registration data information is used to create a merchant attrition model.

According to various embodiments, multiple models can be constructed and analyzed for churn predictive power. Examples include a logistic regression model, a survival model, and a neural network model, as described below.

In addition, embodiments of the invention utilize unique algorithms for standardizing addresses from an attrition detection perspective. For example, the complete USPS (United States Postal Service) address standardization process is computationally expensive and is not needed for attrition detection. Corrective measures are applied to ensure accuracy, such as performing a data audit, identifying unique merchants with multiple keys, removing special characters in the data, standardizing key work, executing address matching logic, and creating unique merchant keys.

In one embodiment, a service provider, such as Discover Financial Services of Riverwoods, Ill., directly maintains a relationship with merchants. In another embodiment, the service provider interacts with merchants through acquirers. Acquirers act as an intermediary between the merchants and the service provider by maintaining a relationship with the merchants on behalf of the service provider. The service provider may have limited data for the merchants acquired because the relationship with the merchants is primarily owned by the acquirers.

As described, merchants are free to switch acquirers but can continue using the service provider's payment network. When merchants switch acquirers, the merchants are represented by a new merchant key in the service provider data. This raises the challenge of identifying a merchant uniquely. It is imperative for the service provider to track transaction activity of its merchants and take preventive measure if the service provider finds a relationship with a merchant deteriorating. There is also a need to create an early warning system, which will help the service provider identify the merchants that are at risk of attrition. The service provider needs to understand the profile of the merchants that are likely to stop transacting in the near future. An appropriate marketing and promotional strategy is then devised for retaining these merchants.

Embodiments of the disclosure provide a comprehensive framework to identify a merchant uniquely by matching the address and business name. Also, using sophisticated statistical techniques, such as logistic regression, survival analysis, and/or neural networks, a predictive model can be developed to identify the merchants that are likely to attrite in the near future.

In some embodiments, individual acquirers have visibility to just their own portfolio but the service provider has access to all acquirers' portfolios through the network transactions. The ability for other acquirers to build such models may be limited.

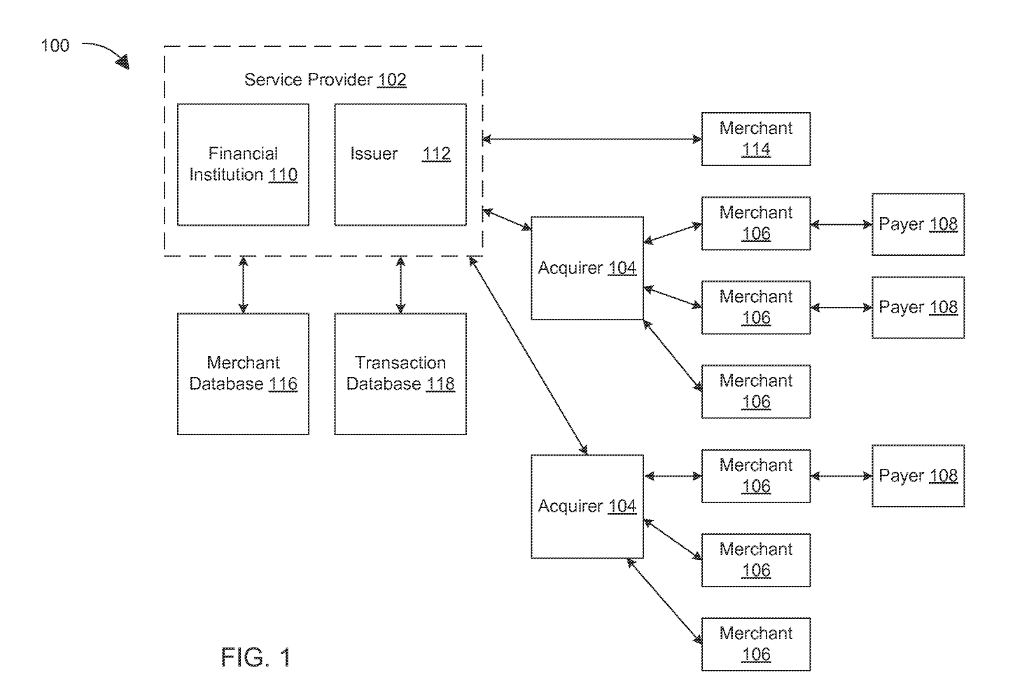

FIG. 1 is a conceptual diagram of a payment network 100, according to one embodiment of the disclosure. As shown, the payment network 100 includes a financial institution 110, an issuer 112, acquirers 104, merchants 106, 114, payers 108, merchant database 116, and transaction database 118. In one embodiment, the financial institution 110 and the issuer 112 comprise a single entity, labeled service provider 102. In other embodiments, the financial institution 110 and the issuer 112 are separate entities. Each of the financial institution 110, the issuer 112, the acquirers 104, the merchants 106, and the service provider 102 may be implemented as one or more computerized systems that include one or more processors and one or more memories storing instructions executed by the one or more processors.

As described, in one embodiment, the service provider 102, such as Discover Financial Services of Riverwoods, Ill., directly maintains the relationship with some merchants 114. In another embodiment, the service provider 102 interacts with merchants 106 through acquirers 104. Acquirers 104 act as an intermediary between the merchants 106 and the service provider 102 by maintaining a relationship with the merchants 106 on behalf of the service provider 102. The service provider 102 may have limited data for the merchants 106 acquired because the relationship with the merchants 106 is primarily owned by the acquirers 104.

A payer 108 is issued a payment card from an issuer 112. The financial institution 110 provides financial backing for the payment card 112. When a payment is made by the payer 108 at the merchant 106 or 114, transaction data for the transaction is stored in transaction database 118. For example, the transaction database 118 may include transaction amounts, transaction dates, and transaction counts for each merchant, among other things.

In some embodiments, apart from the transactional data, the service provider 102 also requests from the acquirers 104 and merchants 106 to submit registration information. The registration information includes data elements as specified in certain operating regulations. Examples of data elements include location information, contact information, merchant category information, and processor characteristics. The data elements are stored in merchant database 116.

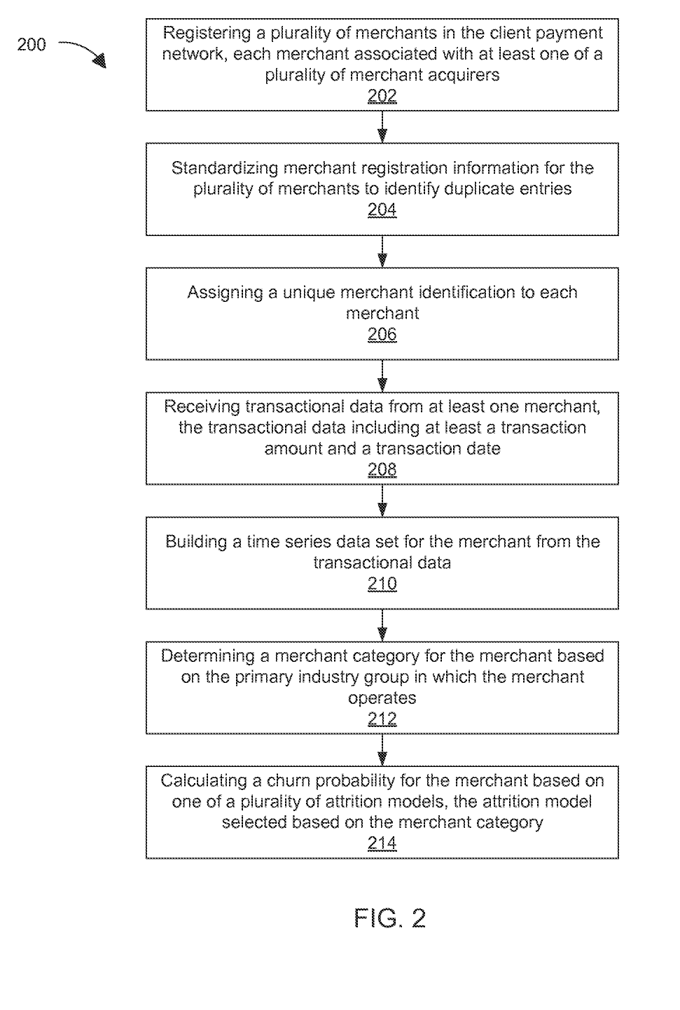

FIG. 2 is a flow diagram of method steps for predicting merchant attrition in a payment network, according to one embodiment of the disclosure.

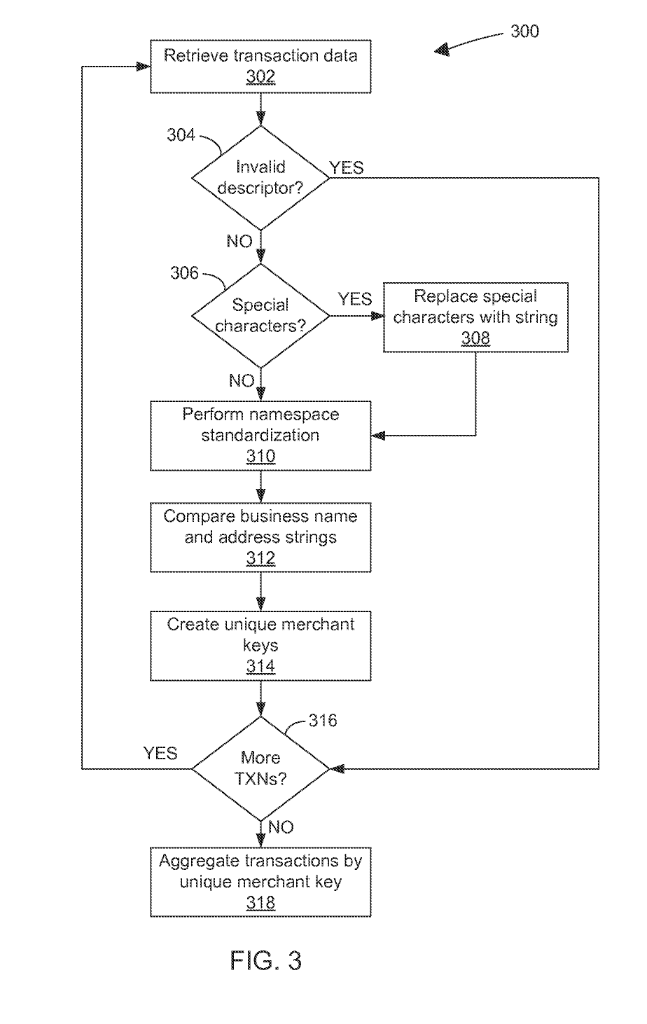

As shown, the method 200 begins at step 202, where a service provider registers a plurality of merchants in the client payment network, each merchant associated with at least one of a plurality of merchant acquirers. At step 204, the service provider standardizes merchant registration information for the plurality of merchants to identify duplicate entries. Step 204 is described in greater detail below in FIG. 3.

At step 206, the service provider assigns a unique merchant identifier to each merchant. At step 208, the service provider receives transactional data from at least one merchant, the transactional data including at least a transaction amount and a transaction date. Steps 206 and 208 are described in greater detail below in FIGS. 3-5.

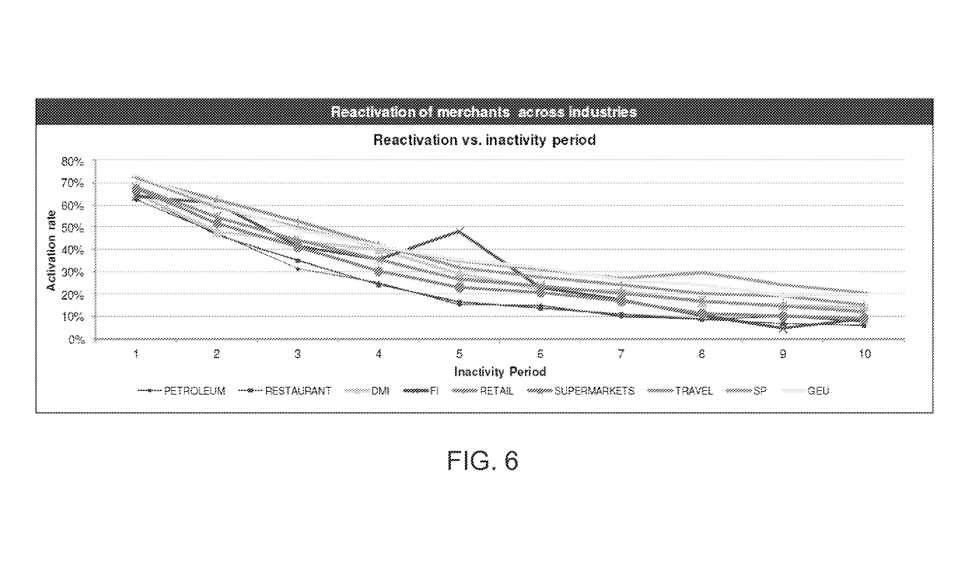

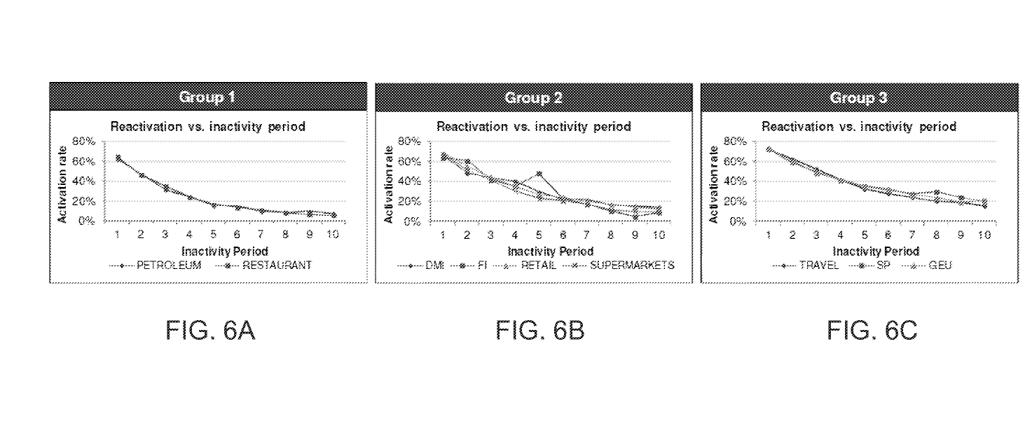

At step 210, the service provider builds a time series data set for the merchant from the transactional data. Step 210 is described in greater detail below in FIG. 6.

At step 212, the service provider determines a merchant category for the merchant based on the primary industry group in which the merchant operates.

At step 214, the service provider calculates a churn probability for the merchant based on one of a plurality of attrition models, the attrition model selected based on the merchant category.

FIG. 3 is a flow diagram of method steps for standardizing merchant registration information, according to one embodiment of the disclosure. As shown, the method 300 begins at step 302, where a service provider receives transaction data for a particular transaction. The transaction data for a particular transaction may include a merchant name, merchant address, merchant key, transaction amount, transaction date and time, geographic location information for the transaction, among others.

In some embodiments, the transaction data received has multiple merchant keys assigned to the same merchant. This can happen when a merchant has multiple POS terminals registered to different acquirers. These POS terminals are assigned different merchant keys. Also, some merchants can switch acquirers and are assigned a different merchant key during this process. These issues are addressed by embodiments of the disclosure in order to correctly identify merchants that have attrited. In some embodiments, business name and address standardization is performed, which is explained below.

At step 304, the service provider determines whether the transaction data includes invalid descriptors. If so, the transaction data for this transaction is discarded and the method 300 proceeds to step 316, where the service provider determines whether there are any more transaction to process. If no, then the method 300 proceeds to step 318, described below. If yes, the method returns to step 302, described above.

Referring again to step 304, if the service provider determines that the transaction data does not include invalid descriptors, then the method 300 proceeds to step 306. At step 306, the service provider determines whether any special characters exist in the transaction data.

If the service provider determines that special characters do exist in the transaction data, then the method 300 proceeds to step 308. At step 308, the service provider replaces the special characters with a string. For example, the business name and address fields may have some special characters included therein. Examples of special characters include “#” and “S.” These special characters do not provide any valuable information to differentiate the merchants and hence are removed from the analysis. Also, various numeric values associated with the business name can be removed. A TRANSLATE function replaces specific characters with a string. In one example, special characters are replaced with a blank space character. The modified string can therefore have multiple spaces.

Referring again to step 306, if the service provider determines that special characters do not exist in the transaction data, then the method 300 proceeds to step 310. At step 310, the service provider performs namespace standardization. In some embodiments, the modified address field obtained after removing special characters is studied to identify the most frequently occurring errors and short forms. This is performed to reduce the computational time required for matching addresses and also to improve accuracy while matching.

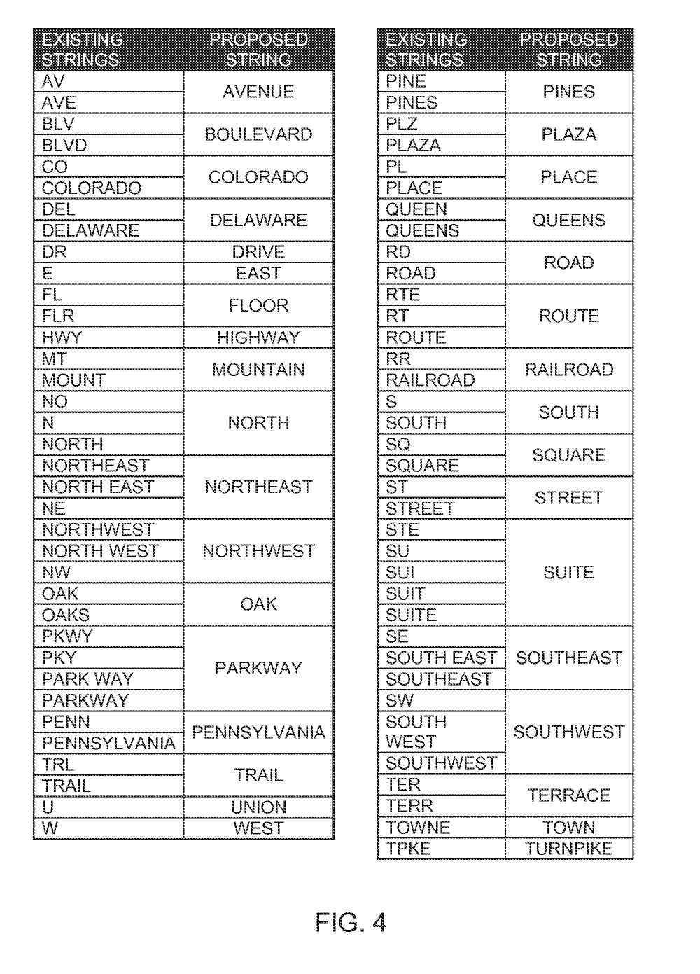

FIG. 4 is a conceptual diagram illustrating short form translations when standardizing addresses, according to one embodiment of the disclosure. In one embodiment, this translation scheme standardizes words for comparison purposes and does not confirm to USPS standardization.

Referring again to FIG. 3, at step 312, the service provider compares business name and address strings to identify potential matches. After the initial standardization of the address field, the address and business name fields are compared across merchants in order to identify potential matches. According to various embodiments, various functions can be used to match text strings like address and business name.

In one embodiment, a COMPLEV function may be used. The COMPLEV function calculates the Levenstein distance (i.e., edit distance)—the number of edits required to transform one string to another. All the edit operations (e.g., insertion, deletion, and replacement) are assigned uniform scores. Computational time of this function is low, but accuracy may be low.

In another embodiment, a COMPGED function may be used. The COMPGED function calculates the Levenstein distance. Scores are generated by assigning weights to the type of edit operation (e.g., insertion, deletion, and replacement). Computational time of this function is high, and accuracy is high.

In yet another embodiment, a SPEDIS function may be used. The SPEDIS function operates in a similar manner to COMPGED, but automatically rejects scores greater than a threshold amount (e.g., 200). Computational time of this function is high, and accuracy is high.

An example is provided below using the COMPGED function to identify merchants with similar addresses. In some embodiments, the drawback of using the COMPGED function, which is high computational time, is overcome by only comparing address and business field for those merchants who belonged to the same state and merchant category. Also, merchant keys that are an exact match of another merchant key, on the basis of name, addresses, and postal code, are separated to decrease the number of iterations required.

In one example, a COMPGED score is generated by assigning weights to different edit operations based on the following rules and summing the results.
1. Inserting or replacing a character at the beginning of the string (cost=200)
2. Inserting, replacing, or ignoring a character not at the beginning of the string (cost=100)
3. Appending a character to the output string after there is no more input (cost=50)
4. Ignoring punctuation (cost=30) or unmatched blanks (cost=10)
5. Repeating a character, changing a double character to a single character, or swapping two adjacent characters (cost=20)
6. Copying a character from the first string to the second string (cost=0)

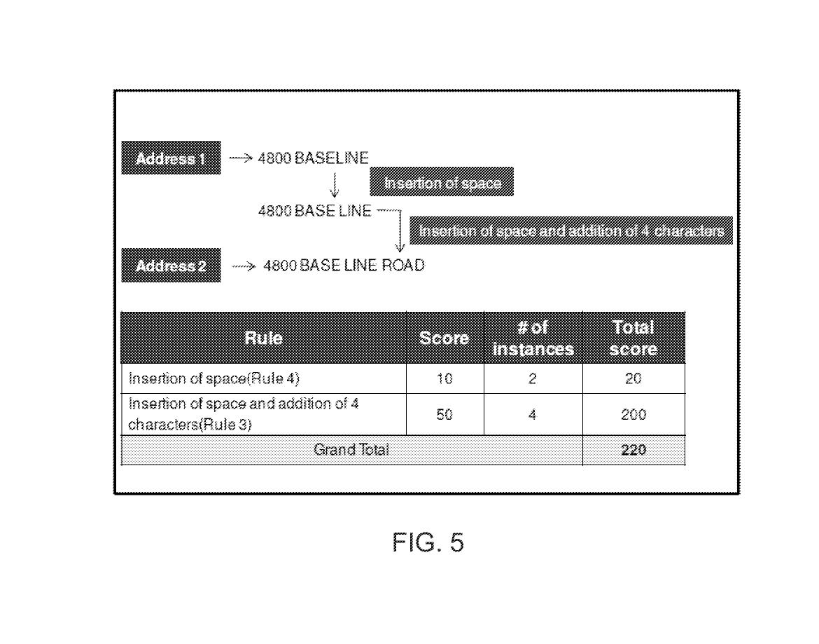

FIG. 5 is a conceptual diagram illustrating an example of implementing the COMPGED function using the above rules, according to one embodiment of the disclosure. As shown, a space is added to the address for a cost of 20 points. Then a space is appended to the address and four additional characters are added for a cost of 200 points. The total cost is 220 points.

At step 314, the service provider creates unique merchant keys for each merchant based on the comparison of the business name and address strings. The comparison scores obtained in step 312 are analyzed to identify a suitable threshold value below which the business name or the address field can be considered the same. In one example, the threshold score is 250 points. Merchants having either of the scores (i.e., business name or address) greater than 250 were considered different. For merchants where the business name is not present, other variables, such as phone numbers, may be compared to decide whether the two merchants are the same.

The merchants that have similar addresses are then grouped together. The grouping can be done by identifying all the links that have been created by the merchants meeting the threshold score.

The unique merchant key assigned to a merchant can be selected randomly or can be selected as the merchant key of one of the matches (i.e., in the care where different merchant keys are present for different matches). The merchants who are exact matches, which were previously separated out to reduce the computational time, are also added and the unique id merchant key is assigned to these merchants as well.

At step 316, the service provider determines whether there are any more transaction to process. If no, then the method 300 proceeds to step 318. At step 318, the service provider aggregates the transactions by unique merchant keys.

### Building Time Series Data

As described above in FIG. 2 (i.e., at step 210), the service provider builds time series data for a merchant based on the transaction data. After data preparation/standardization, a merchant-transaction month level dataset is obtained. In order to execute the modeling exercise, an attrition cut-off is defined as the number of months of inactivity after which only 25% to 30% of the merchants transact again on the payment network. In some embodiments, data is grouped (for example, by quarter) to account of seasonality of transaction behavior.

FIG. 6 is a conceptual diagram illustrating a plot of reactivation versus inactivity period organized by merchant category, according to one embodiment of the disclosure. In this example, merchants are divided into nine categories, including: petroleum, restaurant, DMI (Catalog and Internet merchants), financial institutions (FI), retail, supermarkets, travel, service providers (SP), government, education, and utilities (GEU). Note, service providers (SP) as a merchant category is distinct from service provider 102 in FIG. 1 that processes payment transactions.

In order to define attrition, reactivation rates for all the industries are plotted. The x-axis in FIG. 6 denotes the number of months for which the merchant was inactive, and the y-axis denotes the percentage of those inactive merchants who reactivated in a given period (for example, January 2011 to June 2011).

The reactivation pattern for the different categories are analyzed and it is observed that certain industries showed similar patterns in terms of reactivation of merchants. These industries are then classified into three groups, as shown in FIGS. 6A-6C. Group 1 in FIG. 6A includes Restaurants and Petroleum. Group 2 in FIG. 6B includes DMI, Financial Institution, Retail and Supermarkets. Group 3 in FIG. 6C includes Travel, Service Provider and GEU.

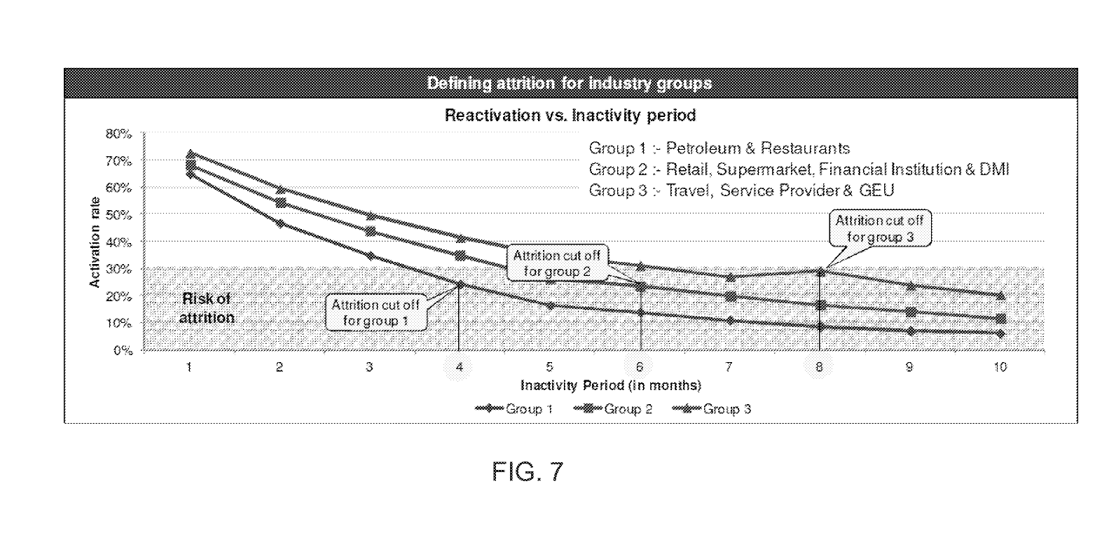

These industry categories are studied and the time period when the reactivation rate fell in between 25% to 30% is taken as the threshold to define attrition. Attrition period for different industry groups is shown in FIG. 7.

In one example, the threshold for Group 1 (e.g., Petroleum and Restaurant) is 4 months, the threshold for Group 2 (e.g., Retail, Financial Institutions, DMI and Supermarket) is 6 months, and the threshold for Group 3 (e.g., Service provider, Travel and Government, Educational & Utilities) is 8 months.

### Merchant Life Cycle

In some embodiments, quarterly level snapshots are created for each unique merchant key. Merchants who have not made any transaction in, for example, the next 4, 6 or 8 months (i.e., based on the industry group in which they fall) from the snapshot month are flagged as attrited. The life cycle of a newly acquired merchant is analyzed in order to determine the appropriate criteria for a merchant to feature in different snapshots.

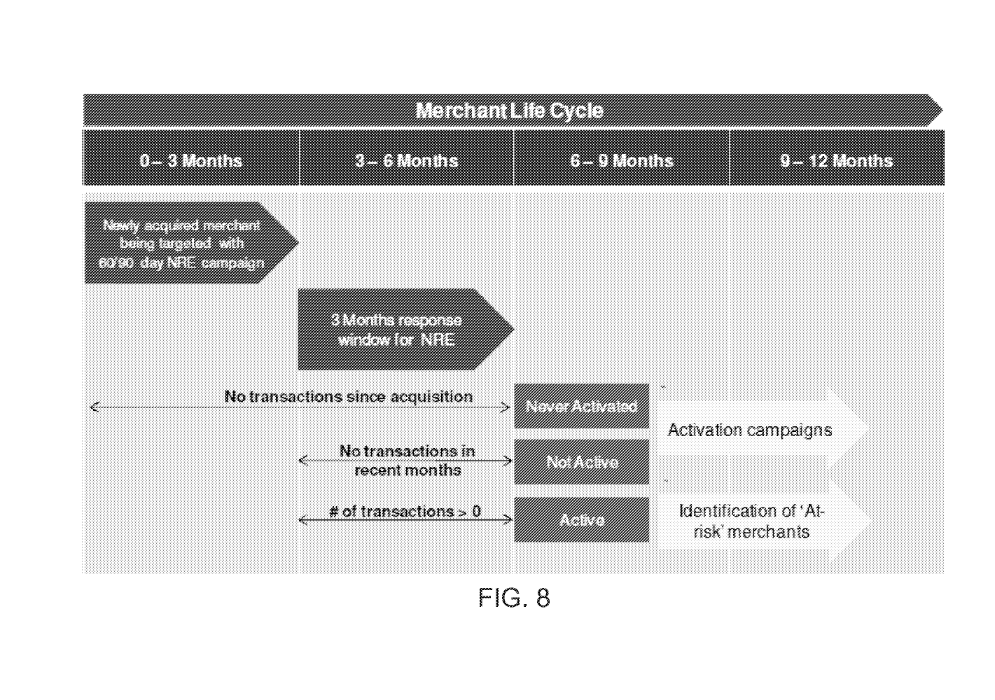

FIG. 8 is a conceptual diagram illustrating a merchant life cycle, according to one embodiment of the disclosure. A newly acquired merchant is expected to activate within six months.

Based on its transactional activity in the first 6 months, the merchant can be classified as “Never Activated,” “Not Active,” or “Active.” The Not Active and Never Activated are targeted via a campaign that promotes activation. The At Risk merchants out of the Active merchants are identified and appropriately targeted.

In order to identify the At Risk merchants from Active merchants, the following criteria have been identified for a merchant to feature in each snapshot:
1. As of the snapshot period, the merchant should have been transacting for at least 6 months.
2. Merchant should have made at least one transaction in the last 3 months.
3. A merchant, once attrited, will not feature in any of the snapshots post attrition, even if that merchant satisfies the above two criteria.

### Model Development and Validation

As described, the merchants are categorized into nine major industry types. These industries are classified into three separate industry groups, as shown in FIGS. 6A-6C. The transaction behavior of merchants belonging to different industry groups (for example, number of transactions in a month, average amount per transaction) varies with respect to each different industry group.

This variation in transaction behavior can potentially lead to a biased model output if it is not accounted for. There are two ways to account for this variation. In one embodiment, the data is transformed using the concept of half-life. In another embodiment, non-transformed data is used using interaction variables.

In one embodiment, half-life is the period of time it takes for a substance undergoing decay to decrease by half. The name was originally used to describe a characteristic of unstable atoms (radioactive decay), but it may apply to any quantity which follows set-rate decay. The concept of half-life is applied to merchant attrition in the following manner.

First, all the merchants in a particular month are shortlisted. Then, attrition in this group of merchants is tracked over a period of time on a monthly level. The “decay curve” is plotted and the rate of decay (X) is determined using the following equation:

N=Nₒ*e^{-λt} (Equation 1),

where,
Nₒ=the total number of samples at the start,
N=the total number of samples remaining after the time elapsed,
t=the time elapsed, and
λ=the rate of decay.

Half-life is calculated on the basis of the rate of decay in the following manner. In some embodiments, the half-life defines the time required for half of the starting population of merchants to attrite, or “decay,” away from the acquirer within a merchant classification industry group. Let half of the initial samples remain in time t. Therefore:

(Nₒ)/2−Nₒ*e^{-λt}

½=e^{-λt}

2=e^{λt}

ln 2=λt

Therefore half-life t is denoted by:

t=(ln 2)/λ (Equation 2),

where,
ln 2=natural logarithm of 1 (i.e., approximately 0.693), and
λ=the rate of decay.

Transaction variables can be transformed on the basis of the variation in half-life across industries in the following way. The half-life of any particular industry is used as the base half-life (restaurants, in one example). For all the other industries, the ratio of its half-life with the base half-life is calculated and denoted as the respective factor for each industry. All the transaction variables are divided by this factor in order to determine the transformed value of the variables.

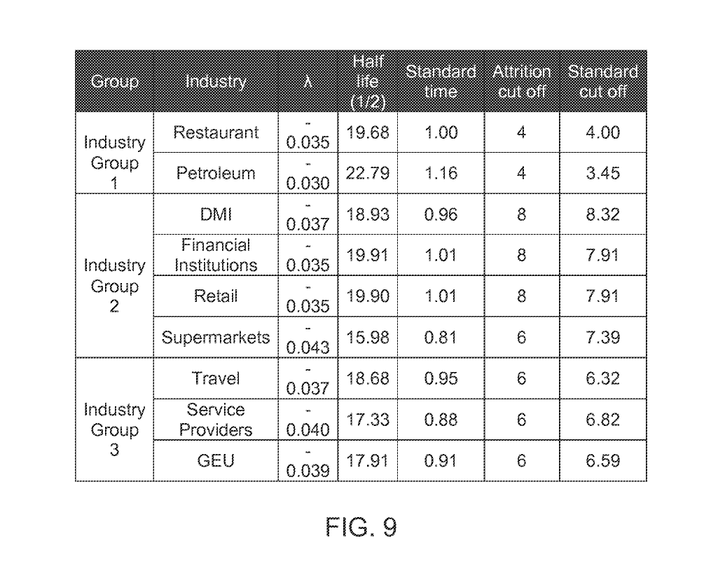

FIG. 9 is a table illustrating a transformation using half-life, according to one embodiment of the disclosure.

In embodiments that use non-transformed data, the variation in transaction behavior across industries is accounted for by using interaction variables during the modeling exercise. The transactions of all the merchants belonging to only that industry were considered while evaluating parameters for a particular merchant.

In some embodiments, the half-life transformation applies to any time-defined variable, where we replace the time unit with the transformed half-life time period. An example includes transaction count per month being replaced (i.e., transformed into) with transaction count per half-life period.

The non-transformed variables are not dependent on time. These variables are used in the models without any transformation. Examples include merchant classification code and geography.

In some embodiments, a bivariate analysis is carried out for each of the independent variables of the analytical dataset and attrition. Based on the bivariate analysis, the direction of effect of each explanatory variable on the dependent variable is determined.

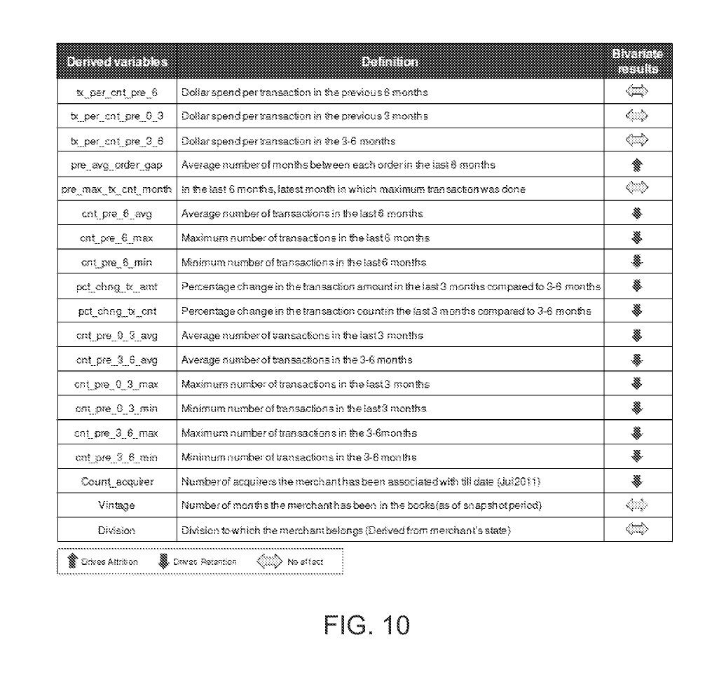

FIG. 10 is a table indicating bivariate analysis results, according to one embodiment of the disclosure. Correlation analysis is performed on the independent variables to determine whether the effect of one of the variables is explained by some other variable. A pair of variables are said to be highly correlated if the correlation coefficient between them is either greater than 0.8 or less than −0.8. In some embodiments, one of these two variables is removed in the multi-collinearity analysis stage.

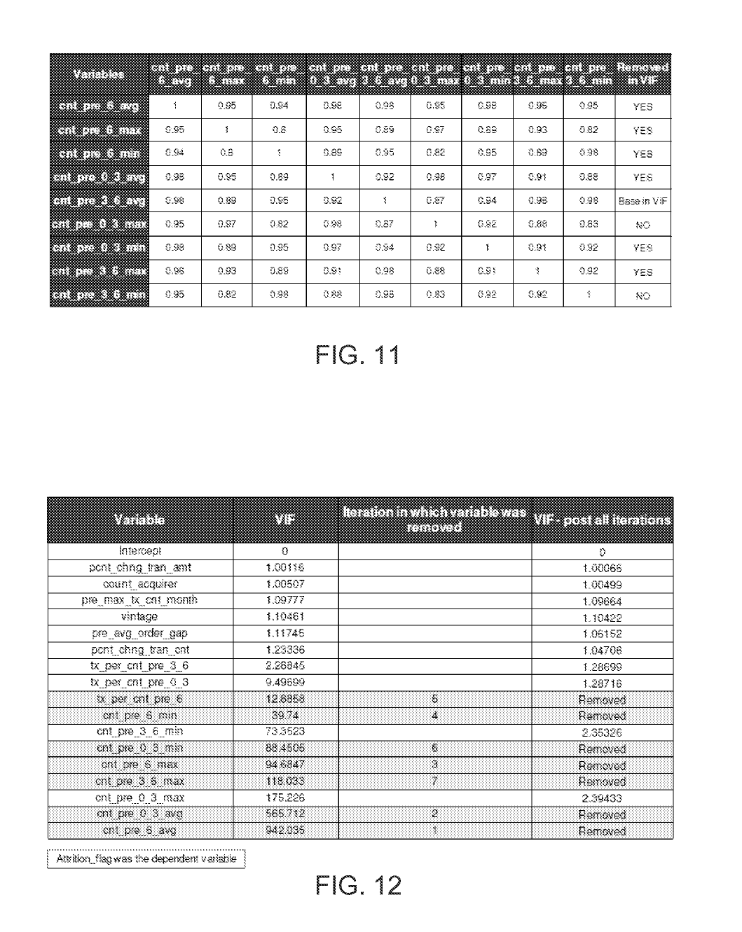

FIG. 11 illustrates a correlation matrix of only those variables which are highly correlated, according to one embodiment of the disclosure. As shown, six out of these nine variables are removed in the multi-collinearity stage, which is explained below.

A multivariate regressive analysis is performed on the independent variables and the dependent variable to determine multi-collinear relationships among the independent variables. A Variance Inflation Factor (VIF) is used determine the highly collinear set of variables. Explanatory variables with a VIF of more than 3 are eliminated.

Multi-collinearity analysis is an iterative process. The variables with a VIF greater than 3 are eliminated one by one. In one example, the final set of significant variables was obtained after 7 iterations. FIG. 12 illustrates the VIF output of some of the derived variables that were determined to be significant after the multi-collinearity stage, according to one embodiment of the disclosure. As shown, the highlighted variables are removed after multi-collinearity analysis. It can be inferred that these 7 variables are already explained by one of the other remaining variables.

### Logistic Regression Model

In statistics, logistic regression (sometimes called the logistic model or logit model) is used to predict the probability of occurrence of an event by fitting data to a logit function logistic curve. Logistic regression is a generalized linear model used for binomial regression. Like many forms of regression analysis, logistic regression makes use of several predictor variables that may be either numerical or categorical.

Logistic regression analysis can be applied to a number of problems. It has a variety of applications, especially in the areas of medical, social sciences, and marketing. Embodiments of the disclosure use logistic regression analysis to determine the propensity of a merchant to stop accepting payment cards offered by a service provider (e.g., service provider 102), given the merchant's historical transaction pattern.

Many procedures in SAS business analytics software can be used to perform logistic regression analysis: CATMOD, ENMOD, LOGISTIC, and PROBIT, for example. Each procedure has special features that make it useful for certain applications. For some applications, LOGISTIC is the preferred choice. The LOGISTIC procedure fits binary response or proportional odds models, provides various model-selection methods to identify important prognostic variables from a large number of candidate variables and computes regression diagnostic statistics.

The base dataset used for building the logistic model for merchant attrition is the snapshot data created above. Two separate models are built for the transformed and non-transformed datasets. Various steps are involved in modeling both the datasets, i.e., bivariate analysis, the correlation matrix, and multi-collinearity check, followed by model calibration and validation.

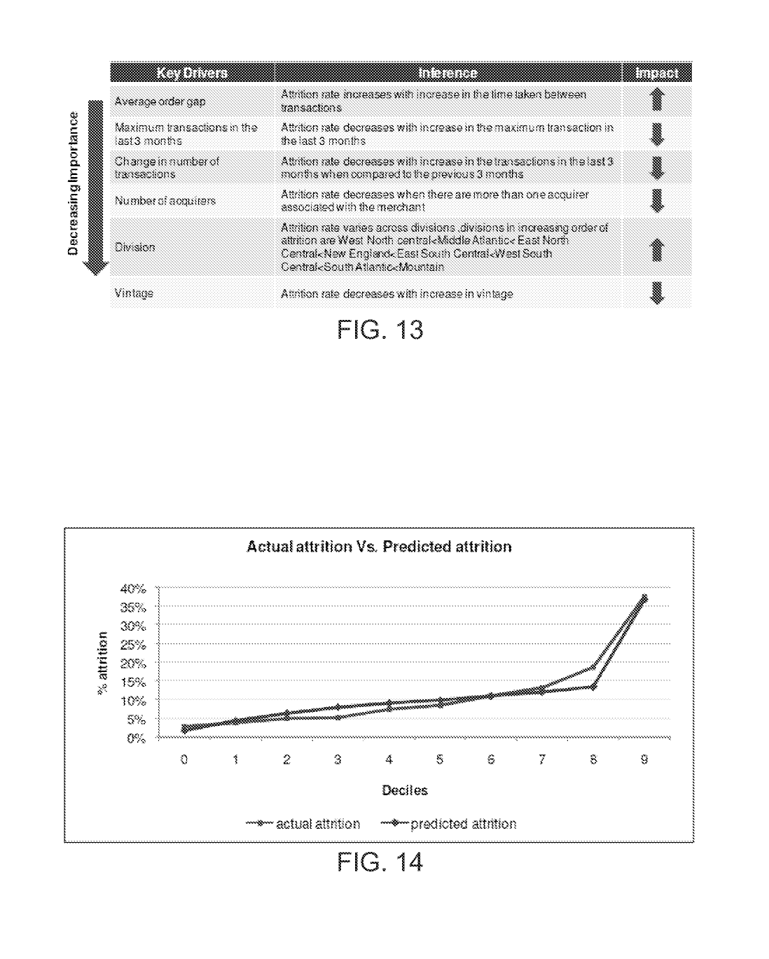

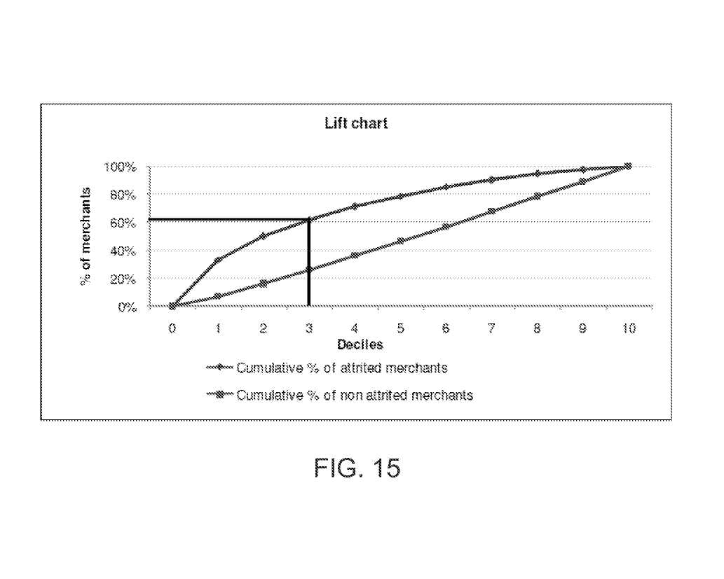

FIG. 13 is a table illustrating variables that emerged as significant drivers of attrition in transformed data, according to one embodiment of the disclosure. Logistic regression was applied in this case using a stepwise regression technique. FIG. 14 is graph of actual versus predicted attrition using a regression model with transformed data, according to one embodiment of the disclosure. As shown, the curve predicted attrition curve follows a similar trend the actual attrition. In certain declines, the model was under- or over-predicting attrition. FIG. 15 is a lift chart illustrating attrition prediction using the logistic regression model with transformed data, according to one embodiment of the disclosure. As shown, the model is able to predict approximately 61% of merchants that are likely to attrite after analyzing only 30% (i.e., 3rd decile) of the data.

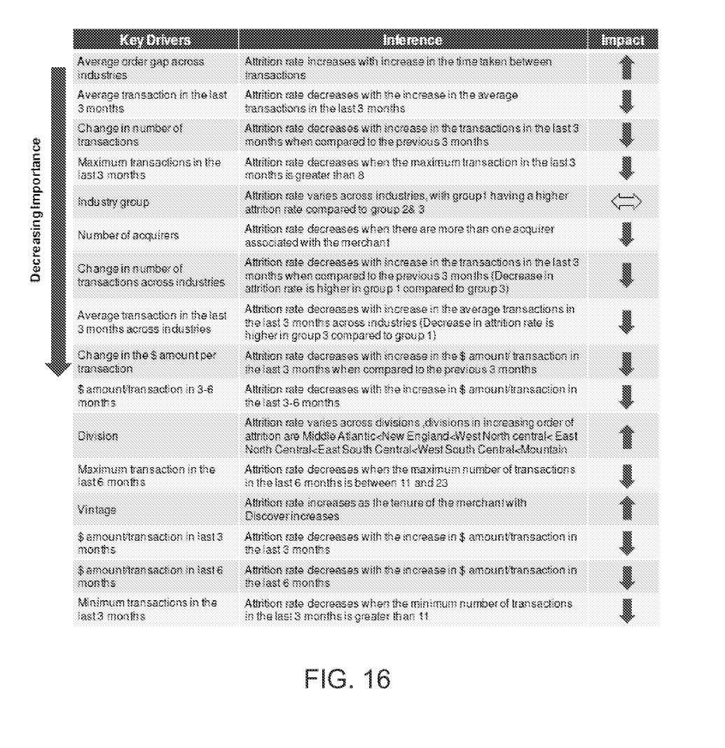

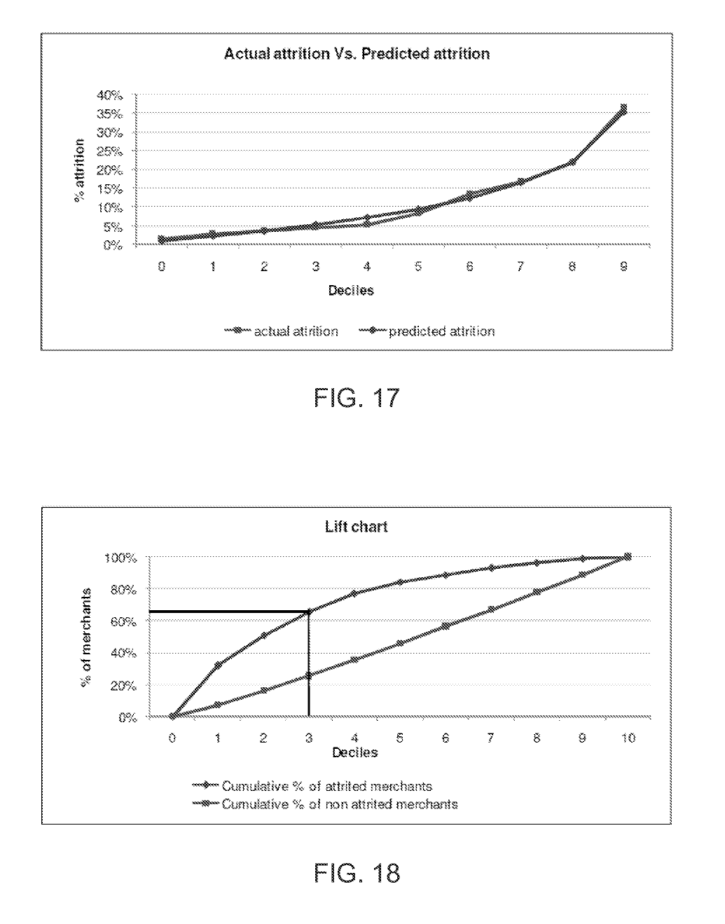

FIG. 16 is a table illustrating variables that emerged as significant drivers of attrition in non-transformed data, according to one embodiment of the disclosure. Logistic regression was applied in this case using a stepwise regression technique. FIG. 17 is graph of actual versus predicted attrition using a regression model with non-transformed data, according to one embodiment of the disclosure. FIG. 18 is a lift chart illustrating attrition prediction using the logistic regression model with non-transformed data, according to one embodiment of the disclosure. As shown, the model is able to predict approximately 65% of merchants that are likely to attrite after analyzing only 30% (i.e., 3rd decile) of the data.

### Survival Analysis Model

In another embodiment, survival analysis is used to model merchant attrition. The base analytical data used for survival analysis is same as that for logistic regression. The data in this case is right-censored, as all the merchant data is from their open date, but get censored at the data pull date. Unlike logistic regression, where the model predicts probability to attrite for the next time period, in survival analysis, the model predicts a survival curve for some time period (e.g., the next 12 quarters) for each merchant. The main challenge in implementing survival for this problem is considering the time-dependent covariates as one of the independent variables. PHREG is a SAS procedure for doing survival analysis as it implements the Cox regression model. There are two main advantages of using PHREG over LIFEREG (i.e., another procedure available for survival analysis in SAS). First, unlike parametric methods, Cox's method does not require a particular probability distribution to be selected to represent survival times. Hence the name semi-parametric. As a consequence, Cox's method (often referred to as Cox regression) is considerably more robust. Second, Cox regression makes it relatively easy to incorporate time-dependent covariates. That is, covariates that may change in value over the course of the observation period.

While Cox's model can be modified to allow for time-dependent covariates, the computation of the resulting partial likelihood is much more time consuming and the practical issues surrounding the implementation of the procedure can be quite complex. There are several ways to include time-dependent variables in PHREG. For example, using the time-dependent variables with conditional statements with respect to the time variables, using time-dependent variables as interaction with time variables, or using arrays.

However, one of the biggest limitations of PHREG is that it can develop a model but cannot score a dataset if time-dependent variables are involved. The survival equation has a component of baseline hazard that is left unspecified. Therefore, unlike logistic regression, the scoring of a dataset cannot be done using a data step.

To overcome this hurdle, there are three techniques available to handle repeated events of time-dependent events, including a counting process model, a conditional model, and a marginal model.

In one implementation, a counting process model is used. Here, each event is assumed to be independent and a subject contributes to the risk set for an event as long as the subject is under observation at the time the event occurs. The data for each subject with multiple events could be described as data for multiple subjects, where each has delayed entry and is followed until the next event. This model, thus, ignores the order of the events leaving each subject to be at risk for any event as long as they are still under observation at the time of the event. This implies that a subject could be at risk for a subsequent event without having experienced the prior events.

For the counting process, the layout of the data needs to be changed from merchant level data to merchant and time period level data. Thus, the system would have one record for each merchant and time period combination. This facilitates the use of standard baseline out function to score the data in PHREG.

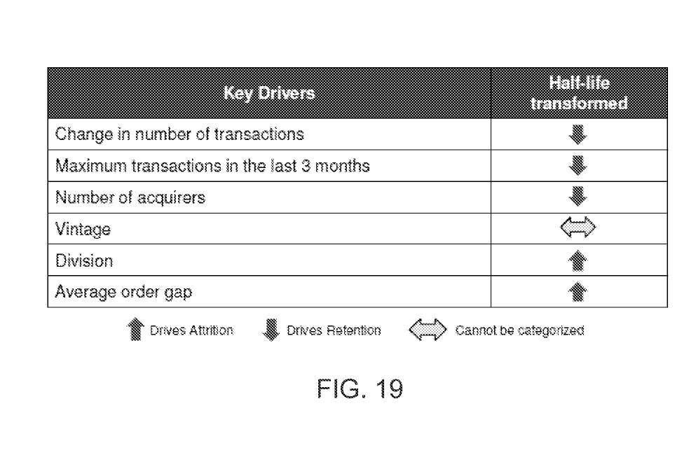

FIG. 19 is a table of variables found to be significant predictors of attrition using the survival mode with transformed data, according to one embodiment of the disclosure.

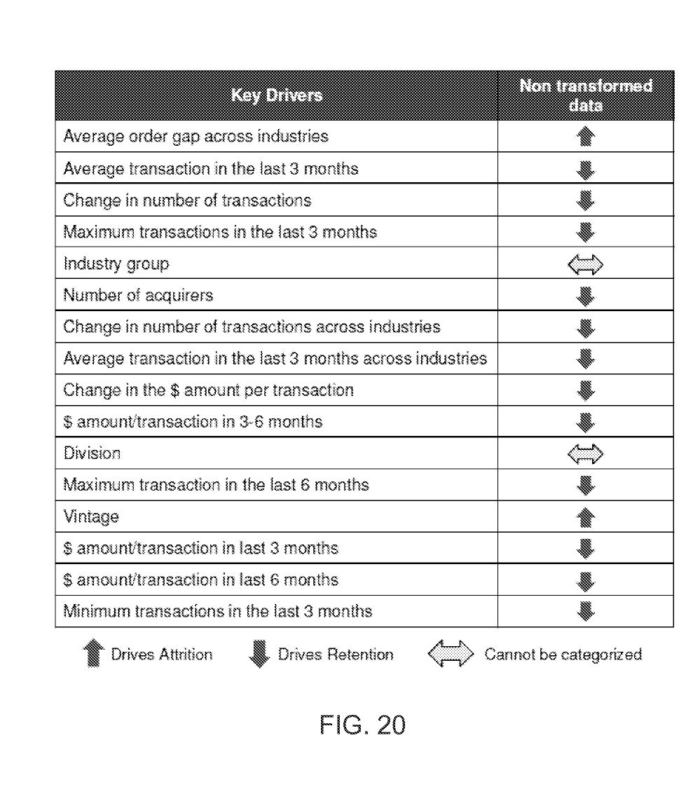

FIG. 20 is a table of variables found to be significant predictors of attrition using the survival mode with non-transformed data, according to one embodiment of the disclosure.

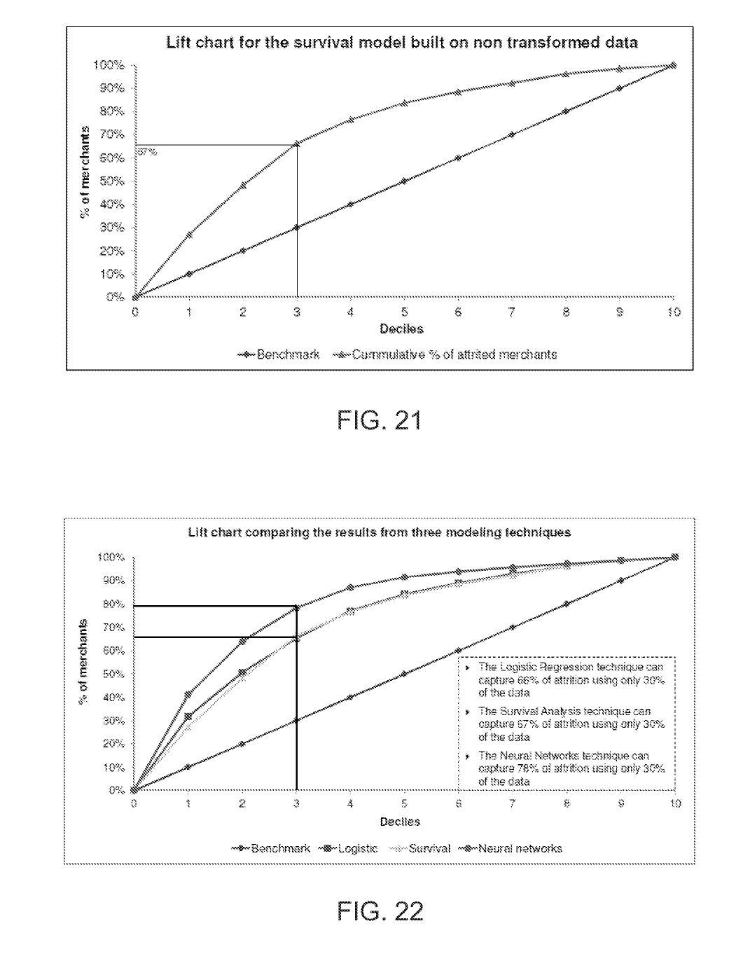

Compared to the model developed on the transformed data (FIG. 19), the model on non-transformed data (FIG. 20) is more accurate as the actual survival and predicted survival curves almost overlap. FIG. 21 is a lift chart illustrating attrition prediction using the survival model with non-transformed data, according to one embodiment of the disclosure. As shown, using the survival model with non-transformed data, approximately 67% of attrited merchants can be captured using the top 30% (in terms of attrition probabilities) of the data.

### Neural Network Model

In yet another embodiment, a neural network model can be used to predict attrition. A neural network model is considered as a two-stage non-linear or classification model. Multiple linear regression, logistic regression, and generalized linear models are some commonly-used special cases. The two-stage process is: first, to derive a hidden layer of variables through a non-linear function acting upon the linear combination of the inputs using activation function a weight matrix of the inputs. Then, additional layers can be derived using the output of the previous state as inputs to create two or more hidden layers. Commonly used activation functions are: hyperbolic tangent, logistic function, arctangent function, and Elliott function, among others. Training and predicting with neural networks is fairly similar to fitting and predicting with more traditional techniques. Some advantages of neural networks are a possibility to represent non-linear relationships in the data, and robustness against noise enabling higher accuracy in prediction.

Neural networks perform well in capturing associations or discovering regularities within a set of patterns where the volume, number of variables, or diversity of the data is high. Due to these characteristics of data, the relationships between variables may be only vaguely understood or difficult to describe adequately using conventional approaches. Historically, neural networks have given higher prediction accuracy than traditional techniques.

Neural networks, in some sense, are the ultimate black boxes. No information regarding the degree to which each input variable were used in prediction is available. Given this limitation, the use of neural networks has the widest application where drivers of the event are not required. To model merchant attrition we have used a five hidden layer of variables to drive maximum accuracy.

FIG. 22 is a lift chart illustrating attrition prediction using the logistic regression model, survival model, and neural network model, according to one embodiment of the disclosure. As shown in this example, the neural network model provides the best results, with approximately 80% of attrited merchants captured using 30% (in terms of attrition probabilities) of the data. Although the neural networks model gives the highest lift, in some cases, survival modeling on transformed data can also be adopted if the drivers of attrition are required to be identified.

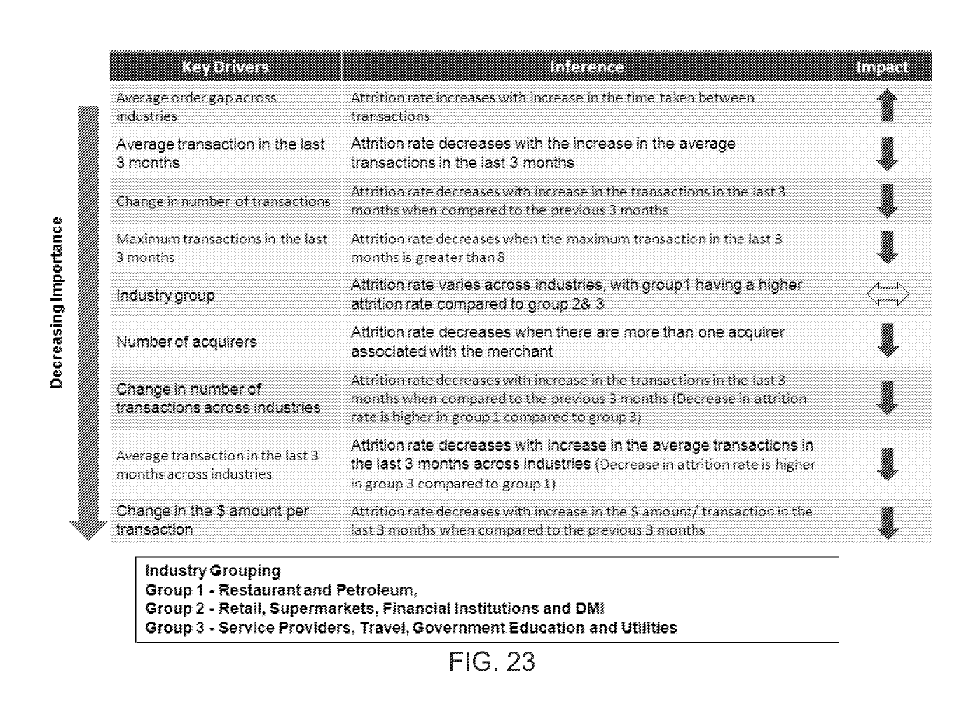

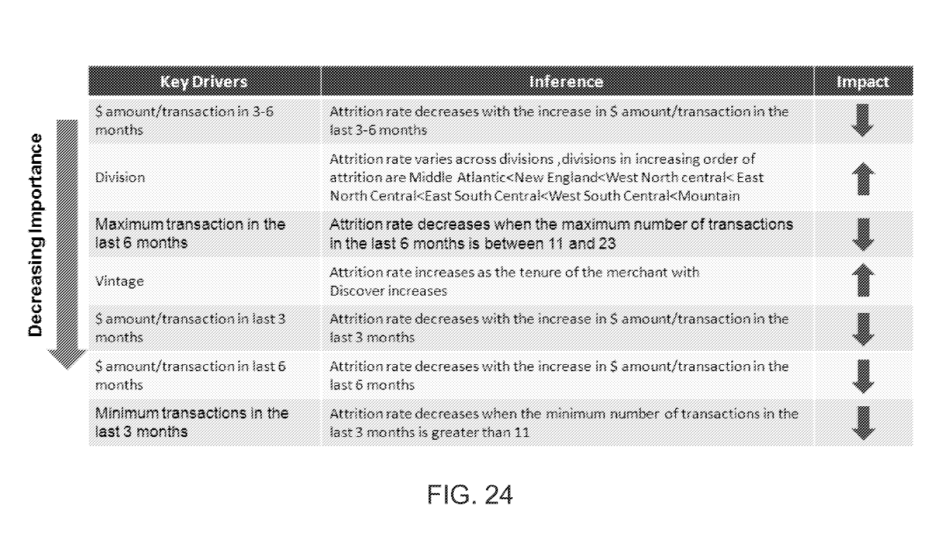

FIG. 23 is a table of different drivers of merchant attrition, categorized by importance and dependent on industry grouping, according to one embodiment of the disclosure. FIG. 24 is a table of different drivers of merchant attrition, categorized by importance, according to one embodiment of the disclosure. In FIGS. 23-24, an increased impact on merchant attrition corresponds to a higher likelihood that the merchant will attrite, and decreased impact on merchant attrition corresponds to a lower likelihood that the merchant will attrite.

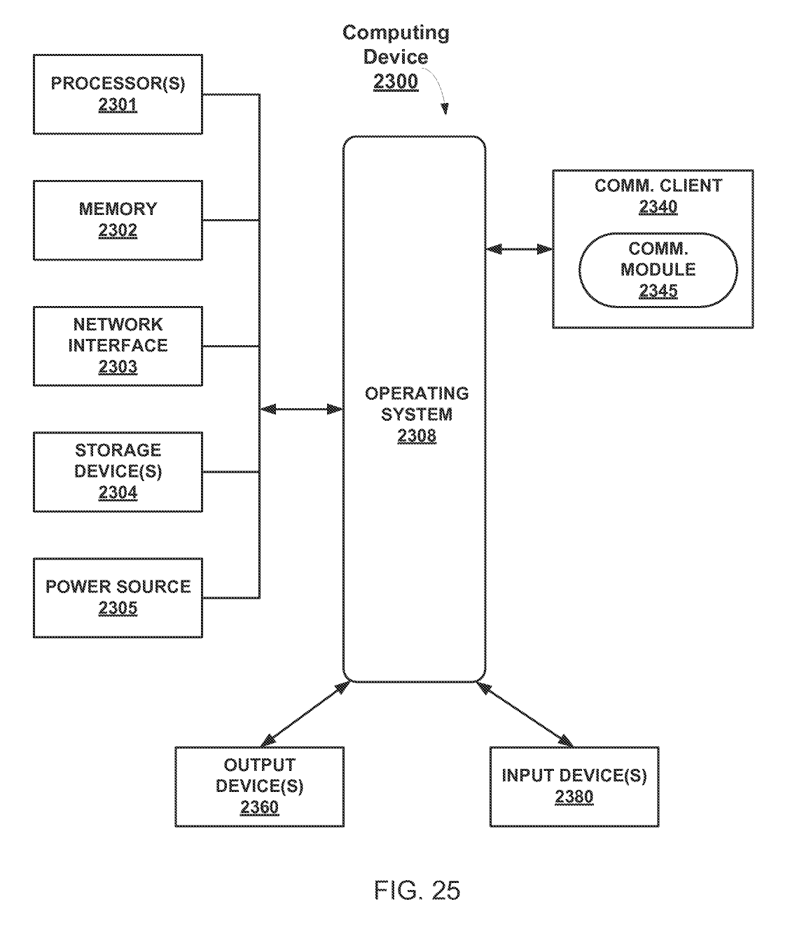

FIG. 25 is a block diagram of example functional components for a computing device 2300, according to one embodiment. One or more computing devices 2300 may be used to implement the functionality of the service provider 102, the acquirers 104, merchants 106, 114, financial institution 110, and issuer 112 in FIG. 1. Many other embodiments of the computing device 2300 may be used. In the illustrated embodiment of FIG. 25, the computing device 2300 includes one or more processors 2301, memory 2302, a network interface 2303, one or more storage devices 2304, a power source 2305, output device(s) 2360, and input device(s) 2380. The computing device 2300 also includes an operating system 2308, a communications client 2340, and a local server 2365 that are executable by the client. Each of components 2301, 2302, 2303, 2304, 2305, 2360, 2380, 2308, 2340, and 2365 are interconnected physically, communicatively, and/or operatively for inter-component communications in any operative manner.

As illustrated, processors 2301 are configured to implement functionality and/or process instructions for execution within computing device 2300. For example, processors 2301 execute instructions stored in memory 2302 or instructions stored on storage devices 2304. Memory 2302, which may be a non-transient, computer-readable storage medium, is configured to store information within computing device 2300 during operation. In some embodiments, memory 2302 includes a temporary memory, area for information not to be maintained when the computing device 2300 is turned OFF. Examples of such temporary memory include volatile memories such as random access memories (RAM), dynamic random access memories (DRAM), and static random access memories (SRAM). Memory 2302 maintains program instructions for execution by the processors 2301.

Storage devices 2304 also include one or more non-transient computer-readable storage media. Storage devices 2304 are generally configured to store larger amounts of information than memory 2302. Storage devices 2304 may further be configured for long-term storage of information. In some examples, storage devices 2304 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The computing device 2300 uses network interface 2303 to communicate with external devices via one or more networks, such as one or more Internet and/or wireless networks. Network interface 2303 may be a network interface card, such as an Ethernet card, an optical transceiver, a radio frequency transceiver, or any other type of device that can send and receive information. Other non-limiting examples of network interfaces include Bluetooth®, 3G (3rd Generation) and WiFi® radios in mobile computing devices, and USB (Universal Serial Bus). In some embodiments, the computing device 2300 uses network interface 2303 to wirelessly communicate with an external device, a mobile phone, or other networked computing device.

The computing device 2300 includes one or more input devices 2380. Input device 2380 is configured to receive input from a user through tactile, audio, and/or video feedback. Non-limiting examples of input device 2380 include a presence-sensitive screen, a mouse, a keyboard, a voice responsive system, a video camera, a microphone, or any other type of device for detecting a command from a user. In some examples, a presence-sensitive screen includes a touch-sensitive screen.

One or more output devices 2360 are also included in computing device 2300. Output device 2360 is configured to provide output to a user using tactile, audio, and/or video stimuli. Output device 2360 may include a display screen (part of the presence-sensitive screen), a sound card, a video graphics adapter card, or any other type of device for converting a signal into an appropriate form understandable to humans or machines. Additional examples of output device 2360 include a speaker, a cathode ray tube (CRT) monitor, a liquid crystal display (LCD), or any other type of device that can generate intelligible output to a user. In some embodiments, a device may act as both an input device and an output device.

The computing device 2300 includes one or more power sources 2305 to provide power to the computing device 2300. Non-limiting examples of power source 2305 include single-use power sources, rechargeable power sources, and/or power sources developed from nickel-cadmium, lithium-ion, or other suitable material.

The computing device 2300 includes an operating system 2308. The operating system 2308 controls operations of the components of the computing device 2300. For example, the operating system 2308 facilitates the interaction of communications client 2340 and local server 2365 with processors 2301, memory 2302, network interface 2303, storage device(s) 2304, input device 2380, output device 2360, and power source 2305.

As illustrated in FIG. 25, the computing device 2300 includes communications client 2340. Communications client 2340 includes communications module 2345. Each of communications client 2340 and communications module 2345 includes program instructions and/or data that are executable by the computing device 2300. For example, in one embodiment, communications module 2345 includes instructions causing the communications client 2340 executing on the computing device 2300 to perform one or more of the operations and actions described in the present disclosure. In some embodiments, communications client 2340 and/or communications module 2345 form a part of operating system 2308 executing on the computing device 2300.

One or more embodiments of the disclosure may be implemented on one or more computer-readable media executed by one or more processors.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computer-implemented method for predictive modeling of merchant attrition in a payment network, the method executed via a processor executing computer-readable instructions read from a non-transitory computer-readable medium, by performing the steps of:
registering a plurality of merchants in the payment network, each merchant associated with at least one merchant acquirer;
standardizing merchant registration information for the plurality of merchants to identify duplicate entries;
assigning a unique merchant identification to each merchant;
receiving transactional data from at least one merchant, the transactional data including at least a transaction amount and a transaction date;
building a time series data set for the merchant from the transactional data;
determining a merchant category for the merchant based on the primary industry group in which the merchant operates; and
calculating a probability for the merchant to switch to a different acquirer based on one of a plurality of attrition models.

2. The method of claim 1, wherein the attrition model is selected based on the merchant category.

3. The method of claim 1, wherein the merchant category is associated with a group of merchant categories, and the probability for the merchant to switch to a different acquirer is based on the group of merchant categories.

4. The method of claim 1, wherein the merchant category is one of restaurants, petroleum, retail, supermarkets, financial institutions, DMI (catalog and Internet merchants), service providers, travel, government, education, and utilities.

5. The method of claim 1, wherein the attrition model is based on logistic regression.

6. The method of claim 1, wherein the attrition model is based on survival analysis.

7. The method of claim 1, wherein the attrition model is based on a neural network model.

8. The method of claim 1, wherein standardizing merchant registration information comprises removing special characters from merchant name information and merchant address information.

9. The method of claim 1, wherein standardizing merchant registration information comprises replacing a shorthand string of characters with a predefined and standardized string of characters.

10. The method of claim 1, wherein standardizing merchant registration information comprises calculating a difference score between a first merchant and a second merchant, wherein if the difference score is below a threshold value, then the first merchant is determined to be the same as the second merchant.

11. The method of claim 1, wherein building the time series data set comprises using time domain transformations corresponding to one of the plurality of attrition models.

12. The method of claim 11, wherein time domain transformations include a half-life transformation.

13. A computer-readable storage medium storing instructions that when executed by a processor cause a computer system to predict merchant attrition in a payment network, by performing the steps of:
registering a plurality of merchants in the payment network, each merchant associated with at least one merchant acquirer;
standardizing merchant registration information for the plurality of merchants to identify duplicate entries;
assigning a unique merchant identification to each merchant;
receiving transactional data from at least one merchant, the transactional data including at least a transaction amount and a transaction date;
building a time series data set for the merchant from the transactional data;
determining a merchant category for the merchant based on the primary industry group in which the merchant operates; and
calculating a probability for the merchant to switch to a different acquirer based on one of a plurality of attrition models.

14. The computer-readable storage medium of claim 11, wherein the attrition model is selected based on the merchant category.

15. The computer-readable storage medium of claim 11, wherein the merchant category is associated with a group of merchant categories, and the probability for the merchant to switch to a different acquirer is based on the group of merchant categories.

16. The computer-readable storage medium of claim 11, wherein the attrition model is based on logistic regression, survival analysis, or a neural network model

17. The computer-readable storage medium of claim 11, wherein standardizing merchant registration information comprises removing special characters from merchant name information and merchant address information and replacing a shorthand string of characters with a predefined and standardized string of characters.

18. The computer-readable storage medium of claim 11, wherein standardizing merchant registration information comprises calculating a difference score between a first merchant and a second merchant, wherein if the difference score is below a threshold value, then the first merchant is determined to be the same as the second merchant.

19. A system comprising:
a merchant registration database;
a transaction database; and
a service provider computing device executing one or more processors to predict merchant attrition in a payment network, by performing the steps of:
registering a plurality of merchants in the payment network in the merchant registration database, each merchant associated with at least one merchant acquirer;
standardizing merchant registration information for the plurality of merchants to identify duplicate entries;
assigning a unique merchant identification to each merchant;
receiving transactional data from at least one merchant, the transactional data stored in the transaction database and including at least a transaction amount and a transaction date;
building a time series data set for the merchant from the transactional data;
determining a merchant category for the merchant based on the primary industry group in which the merchant operates; and
calculating a probability for the merchant to switch to a different acquirer based on one of a plurality of attrition models.

20. The system of claim 19, wherein a merchant point-of-sale terminal is configured to transmit transactional data to the service provider computing device via an acquirer computing device.
